(19) United States
(12) Patent Application Publication
(10) Pub. No.: US 2003/0015102 A1
(43) Pub. Date: Jan. 23, 2003

(54) Purifying system and method

(76) Inventor: Darcy D. Moen Cypert, Highland, MI (US)

Correspondence Address: Robert R. Lech, Esq., Calfe, Halter & Griswold LLP, 21 East State Street, Suite 1650, Columbus, OH, 43215-4243, US

(21) Appl. No.: 10/138,611

(22) Filed: May 3, 2002

Related U.S. Application Data
(60) Provisional application No. 60/288,383, filed on May 3, 2001.

(51) Int. Cl. A01J 11/04

(52) U.S. Cl. 99/467

(57) ABSTRACT

A method of making and using and a system is taught for purifying a surface of an object, such as a foodstuff. The method of making the system includes depositing a substance on an interacting portion of the system. The system comprises a holding portion forming at least one compartment for storing the interacting portion. The system preferably includes a second interacting portion having water dispensed thereon and stored within a second compartment.

### RELATED APPLICATION

This application claims priority to U.S. Provisional Application Ser. No. 60/288,383 filed May 3, 2001, which is incorporated herein by reference in its entirety.

### BACKGROUND OF THE INVENTION

The present invention is related to a method of making a system for purifying, method of using a system for purifying, and a system for purifying, and more particularly to this regarding a system for purifying foodstuff.

In order to grow and protect fruits and vegetables many chemicals are placed on or around the fruits and vegetables. After the fruits and vegetables are harvested, processed, shipped, and displayed many of the chemicals remain on the fruits and vegetables. In order for a consumer to partake of these fruits and vegetables it is necessary to either wait until one gets home to wash off the chemicals, or look all over a store or shopping center for a bathroom to wash off the chemicals. Another problem is that in many cases water alone will not fully rid these fruits and vegetables of the chemicals used during their production. In those cases some organic or man-made purifying substance needs to interact with the surface of the fruits and vegetables before the fruits and vegetables are completely safe to digest. Unfortunately, carrying around a container of such purifying substances is inconvenient, so it makes it very difficult to partake of the fruits and vegetables while one is out traveling around.

What is needed in the art is a system for purifying fruits and vegetables that is simple, compact, and easy to use.

### SUMMARY OF THE INVENTION

This present invention overcomes all these above-mentioned shortcomings of the prior art systems.

According to an embodiment of the present invention, a method of making and using and a system made is taught for purifying a surface of an object. Making the system comprises depositing a substance on an interacting portion of the system. The system comprises a holding portion and a compartment portion in the holding portion for storing the interacting portion. The method of using the system comprises opening the holding portion to gain access to the compartment portion, removing the interacting portion, and purifying the surface of the object with the interacting portion.

A main advantage of the present invention is that it is a simple, compact, and easy to use purifying system for fruits and vegetables that can be used anywhere. Accordingly, a consumer can partake of the fruits and vegetables right after purchasing them at the store.

### BRIEF DESCRIPTION OF THE DRAWINGS

Further features of the present invention will become apparent to those skilled in the art to which the present invention relates from reading the following specification with reference to the accompanying drawings, in which:

FIG. 1 is an illustration of a method of making a purifying system for fruits and vegetables according to a preferred embodiment of the present invention;

FIG. 2 is an illustration of a system for purifying fruits and vegetables according to a preferred embodiment of the present invention;

FIG. 3 is an illustration of method of using the system for purifying fruits and vegetables according to a preferred embodiment of the present invention; and

FIG. 4 is a cross-sectional view of a holding portion of the system for purifying fruits and vegetables according to a preferred embodiment of the present invention.

### DESCRIPTION OF THE PREFERRED EMBODIMENTS

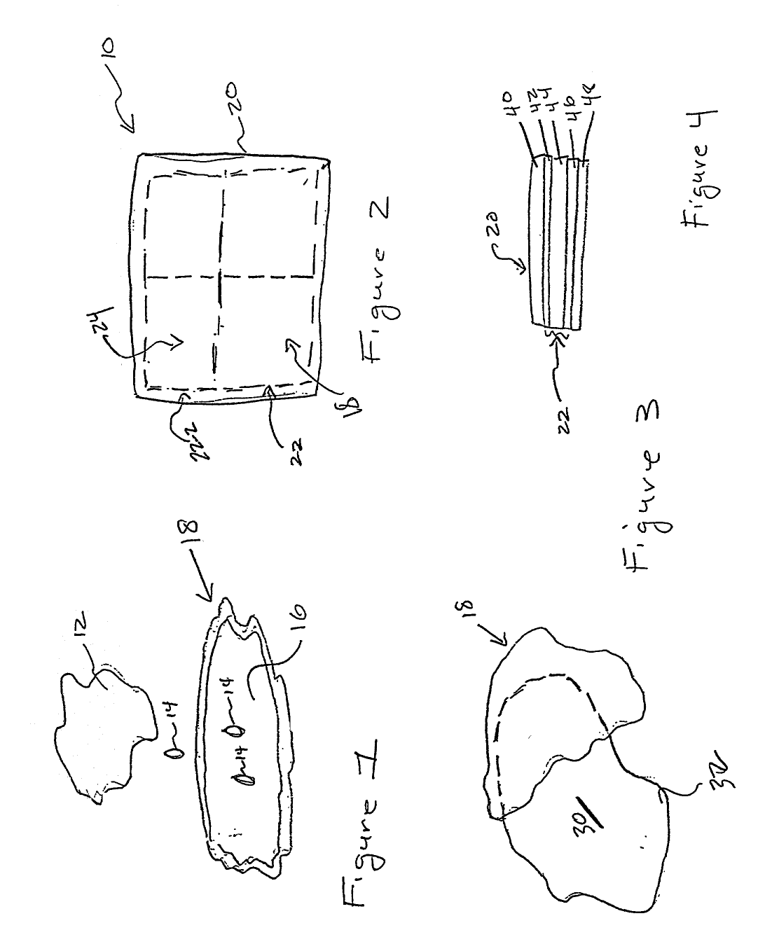

With reference to FIG. 1, a method of making a purifying system 10 (FIG. 2) according to a preferred embodiment of the present invention is shown. The method comprises utilizing a dispenser 12 to dispense a substance 14 onto a surface 16 of an interacting portion 18 of the purifying system 10. The substance 14 is preferably an organic substance that has the properties of neutralizing or purifying any chemicals that remain on fruits and vegetables that are purchased by a consumer in a store. Some such substances are commercially available in spray bottles, and may contain purified water, glycerol, potassium hydroxide, ethyl alcohol, oleic acid, baking soda, citric acid and/or distilled grapefruit oil. In alternative preferred embodiments the substance could be a man-made or non-organic substance with the same properties. Further, the dispenser 12 can either be used manually or within an automated machine.

Now turning to FIG. 2, the purifying system 10 utilized to purify a surface 30 (FIG. 3) of an object 32 (FIG. 3) according to a preferred embodiment of the present invention is shown. This system 10 comprises a holding portion 20 that comprises a compartment portion 22 configured to store the interacting portion 18 of the purifying system 10. The use of the dashed-line to show compartment portion 22 demonstrates that alternative preferred embodiments contemplate utilizing any configuration and number of compartments 22 within the system 10. It is only for convenience of discussion that interacting portion 18 is shown as being stored in the lower, left compartment 22. Further, in alternative embodiments, another compartment 22-2 can comprise a water-soaked interacting portion 24 that would be utilized to wipe any residue left on the surface 30 of the object 32 after the interacting portion 18 interacts with the surface 30 of the object 32. In the preferred embodiment the interacting portion 18 is a paper product moistened with substance 14 and the holding portion 20 is a multi-layered, moisture retaining device, such as a metal and paper device, discussed in more detail below with reference to FIG. 4.

In use, as is shown in FIG. 3, the interacting portion 18 interacts with the surface 30 of the object 32 purifying the surface 30. Thus, a consumer can carry the system 10 on or near their person when running out to a store. Then, after purchasing the object 32, preferably a fruit or vegetable, the consumer can open the holding portion 20 allowing them access to the compartment portion 22 that stores the interacting portion 18. After removing the interacting portion 18 the consumer can use the interacting portion 18 to purify the surface 30 of the object 32, which allows them to immediately consume the object 32.

With reference not to FIG. 4, a preferred arrangement of the holding portion 20 according to a preferred embodiment of the present invention is shown. The holding portion 20 comprises a first paper like layer 40, a first metal like layer 42, an air pocket 44, a second metal like layer 46, and a second paper like layer 48. Through this preferred arrangement the interacting portion 18 stays moist until it is used. It is to be appreciated there are many other types of arrangements of the holding portion 18 that function similarly that are also contemplated within the invention. Further, by using the paper like layers printed material, e.g., labels and instructions, can be adhered to an outside surface 40 of the system 10.

From the above description of the invention, those skilled in the art will perceive improvements, changes and modifications in the invention. Such improvements, changes and modifications within the skill of the art are intended to be covered.

What is claimed is:

1. A method for making a purifying system, comprising:
providing an interacting portion for interacting with a foodstuff; and
dispensing a neutralizing agent onto the interacting portion.

2. The method of claim 1, wherein the neutralizing agent is organic.

3. The method of claim 1, wherein the interacting portion is a paper product.

4. The method of claim 1, wherein the interacting portion is a cloth.

5. The method of claim 1, further comprising storing the interacting portion in a holding portion for later use.

6. The method of claim 5, further comprising storing a water soaked interacting portion in the holding portion.

7. A system for purifying foodstuff, comprising:
a holding portion forming first and second compartments;
a first interacting portion disposed within the first compartment, the first interacting portion including a neutralizing agent dispensed thereon; and
a second interacting portion disposed within the second compartment, the second interacting portion including water dispensed thereon.

8. The system of claim 7, wherein the holding portion is a multi-layered moisture retaining device.

9. The system of claim 7, wherein the holding portion forms more than two compartments.
